(19) United States
(12) Patent Application Publication
(10) Pub. No.: US 2007/0092618 A1
(43) Pub. Date: Apr. 26, 2007

(54) Food handling methods

(75) Inventors: Robert Dennis George Burnell, New South Wales (AU); Athol Chambers, Queensland (AU)

Correspondence Address: STERNE, KESSLER, GOLDSTEIN & FOX P.L.L.C., 1100 NEW YORK AVENUE, N.W., WASHINGTON, DC, 20005, US

(73) Assignee: Strongabulit Pty Ltd., Queensland (AU)

(21) Appl. No.: 10/570,686

(22) PCT Filed: Sep. 3, 2004
(86) PCT No.: PCT/AU04/01192

§ 371 Date: Dec. 13, 2006

(30) Foreign Application Priority Data
Sep. 5, 2003 (AU) 2003904837

(51) Int. Cl. A21D 13/00

(52) U.S. Cl. 426/549

(57) ABSTRACT

An improved food handling method for maintaining a hot food item at a desired temperature, the method comprising the steps of monitoring the heat load applied to at least a portion of a food support surface (3) using at least one temperature sensor associated with the food support surface and a controller (7), and upon application of a heat load to the food support surface (3), the controller (7) identifies a deviation from a zero heat load and applies power to at least one heating means (5) associated with the food support surface (3) based on the deviation.

### FIELD OF THE INVENTION

The present invention relates to improved food handling methods and in particular to improve methods for heating food items to and/or maintaining hot food at a particular temperature.

### BACKGROUND ART

There are many common examples of heating and/or heat maintaining apparatus for heating and/or maintaining heat in articles, e.g. pie warmers, heat lamp serveries, steam heaters, delayed service storage devices and the like.

Foodstuffs have specific internal temperatures when ‘cooked’. If the specific internal temperature is exceeded the foodstuff can be easily overcooked and spoiled. If cooking temperatures are lowered or varied during or after cooking, spoilage of the foodstuff will also occur.

There are five methods used in the cooking of foods. These methods are:
1. Radiation—transfer of heat by emission, for example, a flame
2. Conduction—the direct transfer of heat by contact, for example, an electric frying pan
3. Convection—the transfer of heat in a chamber my moving heated air, for example, a convection oven
4. Steam—the transfer of heat in a chamber using a steam supply, and
5. Microwave—the method of application of high frequency sound waves.

Cooking with the first four methods is a function of temperature versus time. Cold or room temperature food is subjected to heat in excess of 100° until the optimum internal temperature is reached indicating that the food is cooked according to preference. Internal temperatures of the foods vary, for example, bleu rare beef is approximately 45° and a whole baked potato is approximately 88°.

Thus the best cooking and heat maintenance environment occurs when even heat is transferred to a foodstuff.

WO9413184 describes a cabinet with the dual function of both heating and cooling foods. The apparatus is said to provide consistent and uniform heating or cooling of food contained therein using conduction with good contact to the food through the uniform temperature achieved all over the shelf and good contact between the heating surfaces the food on the shelf.

WO9221272 describes a cabinet which cooks and heats food articles or maintains same at a constant temperature. The heating of the surface of the shelves is uniform and what is described as unintended temperature gradients along the surface are said to be eliminated.

FR2738136 describes a heating element which is said to heat up more quickly and retain heat longer than current heater with minimum energy usage.

Whilst the abovementioned inventions recognize the importance of applying even heat to heat the foodstuffs to a constant temperature they only address the issue of heat transfer in a closed and stable environment. One problem not addressed is the effect of temperature changes on an internal environment which occur when relatively inefficient thermostatic controls or forced drafts are used to control heat transfer from heating elements to the foodstuffs via air, and situations such as when access doors are opened and shut.

Conventional heating elements and control systems tend not react quickly enough to prevent heat losses to below a desirable level and often in attempting to restore the environment overheating occurs resulting in drying and dehydration of the foodstuffs. This is particularly applicable to traditional food storage cabinets having heater elements, circulating fans and an air temperature sensor as feedback. The heating element is typically set at the lower end of the cooking range (90° to 130°) and the fans circulate the heated air.

These systems generally attempt to control the temperature of the foodstuff by controlling and adjusting the temperature of the air surrounding the food. The process may be further complicated by the introduction of moisture compensation devices. The food is generally placed on wire shelves to aid air circulation within the cabinet.

When the access door of a cabinet such as the one above is opened, a rush of air, generally at a lower temperature to that in the cabinet, enters the cabinet. This air pushes the temperature of the air in the cabinet down. The temperature sensor notes the decrease in air temperature and immediately turns both the fan and the heating element on to boost the temperature. The food's exposure to the rapid air temperature change is large, due to the mesh shelving and the circulating fans. The food therefore dries and may age rapidly. Examples of the temperature profile in a convection oven, and a conventional Food Holding system (with the door open and closed) are included as FIGS. 9 to 11 herein.

The insulation properties of objects and apparatus for maintaining temperatures are dependent to a large extent on temperature gradients throughout the whole of the body of an apparatus and, very importantly, the surface areas of same.

The methodology described above is not suited for holding hot food at a constant temperature in a dynamic or open environment.

PCT patent application No. PCT/AU99/00815 describes a heating apparatus and methods of heating based on the creation of a plurality of substantially independent heat zones within a cabinet, and accurate electronic monitoring and adjustment of the temperatures of elements within the heat zones. Each of the heat zones is provided with at least one internal shelf or wall which is a laminate or sandwich of two panels and a sheet of electrically resistive material adapted for connection to a power source. The specified sheet materials are glass and the resistive material is a metallised plastics film. We believe that for some applications internal shelving unit(s) may be manufactured in alternative forms to that described in the PCT/AU99/00815, with equivalent if not improved results and an expanded field of use.

It is an object of the present invention to provide a method for heating and maintaining the heat in foodstuffs or other objects with minimal heat variation occurring during periods when the heated object or foodstuff is maintained at a predetermined temperature for later consumption or other purposes.

Further objects and advantages of the present invention will become apparent from the ensuing description which is given by way of example.

It will be clearly understood that, if a prior art publication is referred to herein, this reference does not constitute an admission that the publication forms part of the common general knowledge in the art in Australia or in any other country.

### SUMMARY OF THE INVENTION

The present invention is directed to improved food handling methods, which may at least partially overcome the abovementioned disadvantages or provide the consumer with a useful or commercial choice.

In one form, the invention resides in an improved food handling method for maintaining a hot food item at a desired temperature, the method comprising the steps of monitoring the heat load applied to at least a portion of a food support surface using at least one temperature sensor associated with the food support surface and a controller, and upon application of a heat load to the food support surface, the controller identifies a deviation from a zero heat load and applies power to at least one heating means associated with the food support surface based on the deviation.

The controller may suitably apply the power to the at least one heating means relative to the deviation in heat load of at least a portion of the food support surface from a zero heat load. The application may be directly proportional to the deviation or may be applied according to a predetermined formula. Suitably, there may be a number of food support surfaces in an apparatus, each being a shelf. The controller may preferably then have a limited amount of available power to apply across all of the heating elements and may do so on the basis of the proportion of a particular shelf's heat load compared to the total heat load for all of the shelves. The shelves may preferably be individually controllable and monitored.

The monitoring of the heat load on at least a portion of the food support surface may preferably take place periodically or at predetermined intervals. The controller may control the timing of the monitoring step. The method may also allow manual activation or override of any of the functions.

The heat transfer mechanism operating according to the invention may suitably be conduction. There may be small components of convection and radiative heat transfer but these are preferably minimised in favor of conductive heat transfer. There may suitably be only a ±2° C. fluctuation in the temperature of the holding surface when the heat load is being monitored. This may allow a decrease in the amount of power to be drawn in order to heat the food items.

The temperature of the food support surface may preferably be set at any temperature in the range of between about 1° C. and 99° C. There may be more than one food support surface provided in a food storage apparatus and each may be individually controllable, so that different foods may be held at different temperatures.

The food support surfaces may be controlled so as to not exceed the optimum internal temperature of the particular food items placed on that surface. This may assist in the control of moisture content without the provision of a humidity control system. The method may also provide the ability to raise or lower the core temperature of the food items without inducing “cook on” or beginning the cooking process in the food again.

The optimum internal temperature may be determined according to the type of heating required. For example, if only maintenance of heat is required, then the maximum temperature of the food support surface may not exceed a preset maximum temperature which is equal to the internal temperature of the food item when cooked. This means that once a food item is placed on the food support surface, the item is not further cooked.

A similar condition occurs if the food item is to be defrosted, heated and then its temperature maintained. The shelf may be heated to a defrosting/heating temperature to heat the food, but once the temperature of the item reaches a preset optimum temperature for that particular foodstuff or item, the temperature does not rise above the internal temperature of that particular food item when cooked.

Typically, according to an embodiment of the invention there may be provided an apparatus comprising a body, means of access to the interiors of the body and at least one internal shelf which is a laminate or sandwich of two metal panels and having an interposed electrically conductive serpentine coil adapted for connection to a power source.

The controller may control the system by interrogating the surface temperature of each surface, whether one or more are provided, and comparing it to the preset temperature for that surface. The difference in the temperatures may be used to calculate a heat load. Heat load may be calculated using Fourier's law. This calculation may be performed according to the following formula which is one example only of a formula which may be used for this purpose:
Q=−kAΔT
in which Q=Heat Load in Watts,

k=Thermal conductivity of the material of the food support surface in W/m^{2o}C.,

A=Surface Area in m², and

ΔT=Temperature difference in ° C.

The method may be applied to either closed or open environments. The shelf material may be any type but is preferably one with good thermal conduction properties such as glass aluminum, granite or graded stainless steel.

The activation or application of the power to heat the food support surface may be manual but will generally be automatic and controlled by the controller.

If there is no load on the shelf, power may be applied to the heating means at sufficient levels to maintain the preset temperature. When a heat load is applied to the surface, the controller identifies the differential and if above the preset temperature, the controller turns off the power to the surface. Conversely, if the heat load is negative, power may be supplied to the surface at a level related to the differential.

In another form, the invention resides in an improved food handling method for heating cold food to a preset temperature and then maintaining the food item at a desired temperature, the method comprising the steps of

monitoring the heat load applied to at least a portion of a food support surface using at least one temperature sensor associated with the food support surface and a controller,

controlling the operation of at least one heating means in a first, heating condition in which upon application of a heat load to the food support surface, the controller identifies the heat load and applies power to the at east one heating means to increase the temperature of the food support surface to achieve a zero heat load as quickly as possible and a second, holding condition activated upon reaching the zero heat load, wherein the controller identifies any deviation from the zero heat load and applies power to the heating means based on the deviation.

According to still another form, the invention resides in an improved food handling method for maintaining a preset relative humidity in a temperature maintained environment, the method comprising the steps of

monitoring the relative humidity in the environment,

controlling the relative humidity in the environment by utilizing a humidifier if the relative humidity is too low and extracting excess humidity if the relative humidity is too high.

The monitoring of the relative humidity levels in the environment may preferably be performed using a moisture sensor. The moisture sensor may suitably be linked to a microprocessor or controller. The preset relative humidity desired in the environment may be preset according to the type of food which is to be held in the environment. Typically, the controller may control the relative humidity in the environment such that the relative humidity is restricted to with ±5% of the preset value.

The humidifier may suitably be a sonic humidifier. A sonic humidifier converts electrical energy into mechanical vibrations to generate an aerosol, thereby producing a very fine mist consisting of minute aerosol particles.

The excess humidity may suitably be extracted from the environment using vents. The vents may be associated with fans to assist in the extraction.

The method for maintaining a preset relative humidity in a temperature maintained environment may be utilized in concert with either or both of the method for maintaining hot food at or around a preset temperature or the heat and hold method for warming and maintaining food as described herein.

According to a particularly preferred embodiment of the invention there is provided a heating apparatus comprising a body, means of access to the interiors of the body and at least one internal shelf which is a laminate or sandwich of two metal panels and having an interposed electrically conductive serpentine coil adapted for connection to a power source.

The metal panels can be aluminum panels, approximately 2 millimeters in depth.

The coil is wound in a regular serpentine pattern to provide equal heat distribution to the whole of the major surfaces of the metal panels.

The coil can be a conductive wire having an impedance valve of approximately 6 ohms. per foot. Sixty lineal feet of the wire can be used per square meter of surface area of each shelf.

The peripheral edges of the panels may be joined and sealed by joining strips.

In another preferred form of the invention, the said at least one shelf or wall may comprise a mesh coil embedded in a moldable and settable material such as fiberglass. The mesh may be aluminum mesh.

The apparatus may include an electrical controller interposed between the coil sheet and a power source which is programmable to measure temperatures of the said at least one internal shelf or wall and to provide variable currents to the intermediate sheet.

Monitoring of the surface temperature of the said at least one internal wall of the cabinet can be via by a bi-metallic measuring device.

Electrical signals from the measuring device can be received and processed by a controller which can adjust the level of current fed to the elements of the said at least one internal wall.

Suitably, the controller functions to calculate the differential of one or more food support surfaces and;
(a) Adjust the level of current fed to the heating elements associated with the surface(s) to compensate for negative heat loads and raise temperatures to predetermined levels from 80 to 300° C. for heating chilled food for predetermined time periods in order to raise the internal temperatures from below low range foodsafe maximum temperature to above high range food safe minimum temperature in a minimum time period so as not to promote bacterial growth whilst not exceeding the amount of power available, to provide power for up to and including five surfaces independently of each other and/or,
(b) Adjust the level of current fed to the heating elements associated with the surface(s) to compensate for negative heat loads and maintain predetermined temperatures in heated food above the minimum foodsafe temperature for hot food to inhibit bacterial growth in or on the food items, and below a cooking temperature of the food item or items whilst not exceeding the amount of power available, to provide temperatures of 1 to 99° C. for up to and including ten surfaces independent of each other and/or
(c) Adjust the level of humidity injected or extracted within an apparatus to maintain a predetermined level of humidity from 1 to 100% relative humidity.

According to preferred aspects of the present invention there may be provided a method by which the controller is further programmed to;
(a) Provide pre set or manual activation of the cycle for heating chilled food or the timing of holding periods, and/or
(b) Provide self diagnostic and remedial management in the event of a surface driver failure, and/or (c) Provide for isolation of failed circuit and re-activation of the balance of the operating surfaces, and/or
(d) Provide a timed audible alarm and fault code display in the event of a failed circuit, and/or
(e) Provides hazard assessment critical control points (H.A.C.C.P.) temperature monitoring, logging and recording.

According to a further preferred aspect of the present invention there may be provided a method by which the surface materials can be heated. The heated surface may be a sandwich of two materials having an interposed electrically conductive serpentine coil adapted for connection to a power source via the controller.

A conductive wire coil having an impedance value per foot calculated to suit the application of use and surface size may be used as the heating element. The coil may be wound in a regular serpentine pattern to provide equal distribution to the whole of the surface. The length of wire used per square foot of surface area may be calculated to suit the impedance and application.

According to further preferred aspects of the present invention the surface materials may be have the following characteristics;
(a) A laminate or sandwich may comprise aluminum, stainless steel, glass or engineered stone panels approximately 1.6 to 12 millimeters in thickness.
(b) The surface can comprise an aluminum, stainless, glass or engineered stone having a serpentine coil, element or a heat resistive material fixed to the under side of the upper surface.
(c) The lower surface of the sandwich may be apertured aluminum or stainless steel providing a source of radiated heat.

According to aspects of the present invention the method by which the combination of the controller, surface and heating materials can be used in an open or closed apparatus may be adapted for use as;
(a) Storage or Merchandising—Hold heated food at predetermined temperatures above high range foodsafe minimum temperatures.
(b) Heating and Merchandising—Simultaneously hold heated food at predetermined temperatures above high range foodsafe minimum temperatures whilst sequentially heating chilled food from predetermined temperatures below low range maximum foodsafe temperatures to predetermined temperatures and then hold heated food at predetermined temperatures above high range foodsafe minimum temperatures.
(c) Self Serve Merchandising—Simultaneously hold heated food at predetermined temperatures above high range foodsafe minimum temperatures and hold chilled food or beverages at predetermined temperatures below low range maximum foodsafe temperatures.
(d) Retarding & Proving or Vending—Sequentially hold food chilled at predetermined temperatures below low range maximum foodsafe temperatures, heat the chilled food chilled food from predetermined temperatures below low range maximum foodsafe temperatures to predetermined temperatures and then hold heated food at predetermined temperatures above high range foodsafe minimum temperatures.

### BRIEF DESCRIPTION OF THE DRAWINGS

Aspects of the present invention will now be described by way of example only with reference to the accompanying drawings in which

FIG. 1 is a perspective view of a typical heating and heat maintenance apparatus to which the present invention relates, and

FIG. 2 is a sectional drawing of a shelf for a heating apparatus according to aspects of the present invention, and

FIG. 3 is a diagrammatic drawing showing the imposition of a controller between the power supply and a heating element of a shelf of the apparatus of the present invention,

FIG. 4 of the drawings is a general outline of a microcomputer based temperature controller in accordance with one possible aspect of the present invention, and

FIG. 5 of the drawings is a diagrammatic drawing of an apparatus of the present invention and serves to illustrate how one or more heat zones can be provided with an apparatus.

FIG. 6 is an electronic schematic showing the power supply, microcomputer and software protection sections of the controller.

FIG. 7 is an electronic schematic showing the current sensing circuit and ten identical outputs for controlling the heater elements.

FIG. 8 is an electronic schematic showing ten identical temperature measurement inputs for monitoring the shelf temperatures.

FIG. 9 is an example of the temperature profile in a convection oven.

FIG. 10 is an example of the temperature profile in a conventional Food Holding system with the door closed.

FIG. 11 is an example of the temperature profile in a conventional Food Holding system with the door open.

FIG. 12 is an example of the temperature profile achievable in using the method according to the present invention.

FIG. 13 is a schematic illustrating the humidity adding aspect of the humidity monitoring and adjustment method according to an aspect of the present invention.

FIG. 14 is a schematic illustrating the humidity removing aspect of the humidity monitoring and adjustment method according to an aspect of the present invention.

### DETAILED DESCRIPTION OF THE INVENTION

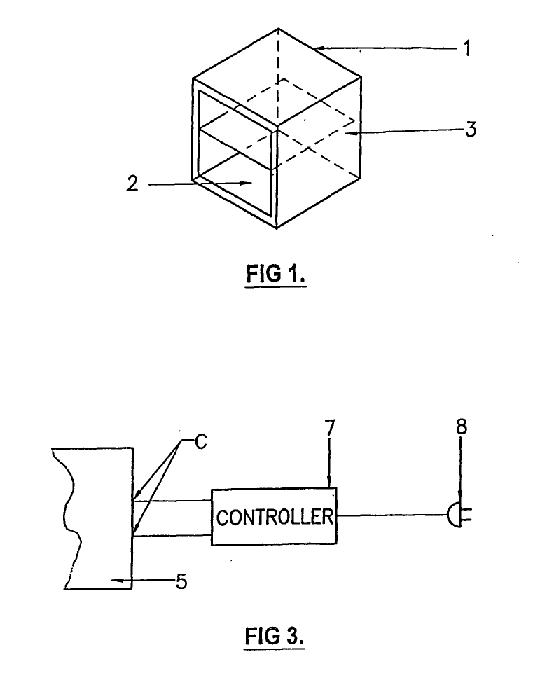

With respect to the drawings FIG. 1 illustrates a typical apparatus to which the present invention relates. A heating environment is provided within a body generally indicated by arrow 1 with access to the interiors of the body being provided by a door or doors 2. The environment may be sub-divided by partitions such as shelves 3 upon which objects to be heated can be rested. The shape of the body may be varied to suit design or other criteria and may include curved portions (not shown).

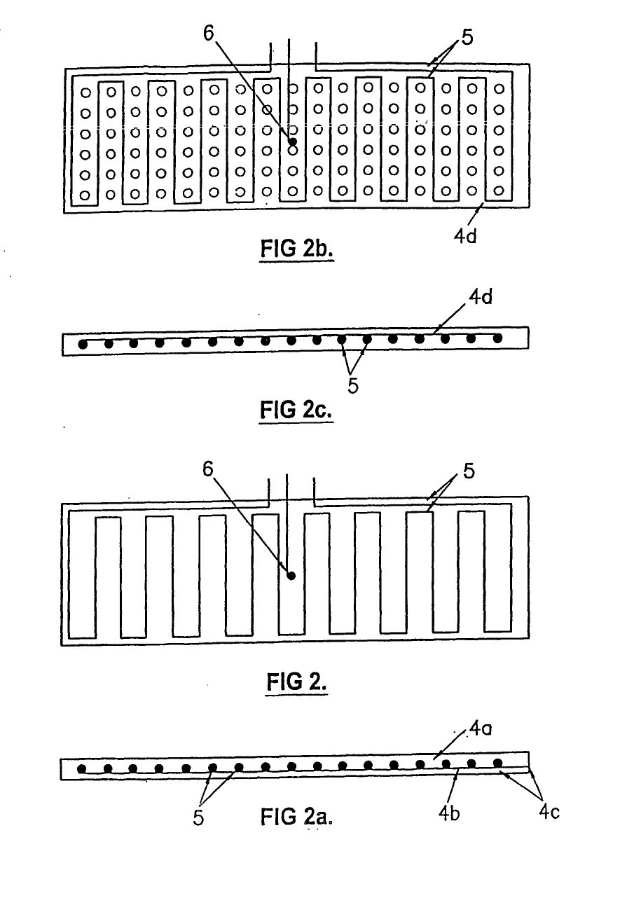

FIG. 2 of the drawings illustrates an internal shelf according to the present invention. The shelf comprises two metal panels 4, an intermediate serpentine coil 5 and a peripheral substantially C-shaped bead 6 which seals the edges of the panels 4. The coil 5 can be glued to one or more of the panels 4 and has direct contact with the panels. The spacing S between the wound sections of the coil may be approximately 20 millimeters and the panels may be 1.2 millimeters thick aluminum panels.

Electrical connections ‘C’ can be made to the coil 5 (see FIG. 3) connecting the coil to a power source 8 via a controller 7. The controller 7 shown in box form in FIG. 3 may include:
(a) rectification and transformation means;
(b) means to vary current supplied to the sheets 5;
(c) a programmer which enables heat levels to be set for specific objects to be heated;
(d) tamper proofing facilities which ensure the program is not incorrectly reset;
(e) alarm/fault systems.

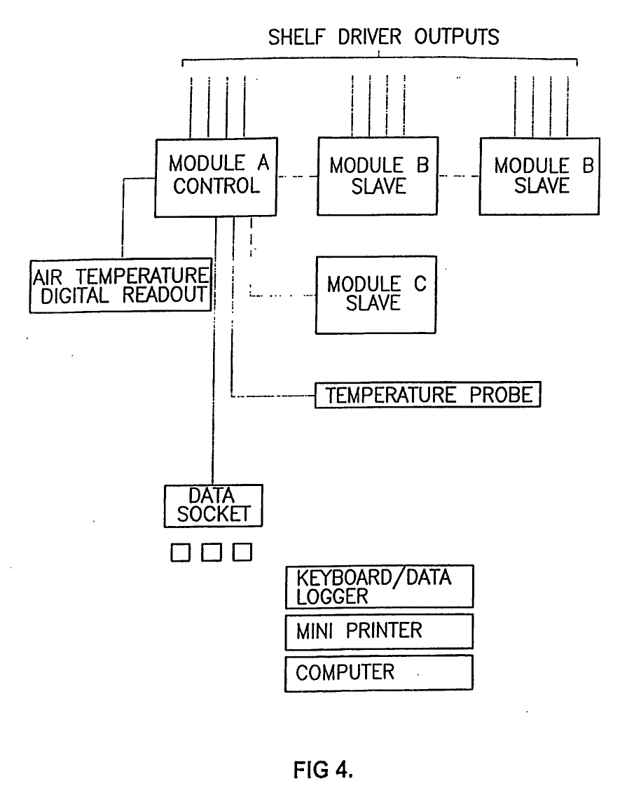

One form of controller may consist of a microcomputer based temperature controller of the general outline illustrated by FIG. 4.

Thermocouples are used as temperature sensors to achieve high accuracy temperature sensing without requiring individual calibration.

The amplifiers are low drift switched capacitor high gain precision devices and amplify the low level signal (40 uV/° C.) from the thermocouples to a level suitable for use by the digital to analogs converter.

The digital to analogs converter takes signals from each of the ten temperature inputs converting these into 10 bits of digital information providing about 0.2° resolution. This information is available to the software running in the microcomputer for the purpose of stabilizing the heating surfaces of the food warming environment and to provide a temperature display during normal operation.

There are ten individual outputs which can individually control up to ten different heated surfaces in the environment. Outputs are switched at the zero crossing points to minimize the electromagnetic interference generated by the cabinet.

The electronics provides two digits of LED display which can display the air temperature within the apparatus over the range 0 to 99° C. and also display diagnostic fault codes.

The software running in the microcomputer allows the environment to be configured with up to ten surfaces being temperature controlled by fixing a thermocouple to a heated surface to a precision of better than +/−2° C. These precisely controlled outputs are used to fix the storage shelf temperatures within the environment regardless of the ambient temperature or food loading applied.

A power supply is provided which produces the ±5V required by the control and computer electronics from the main supply available to the controller.

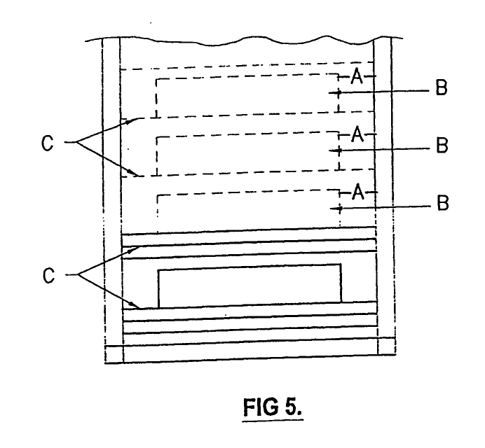

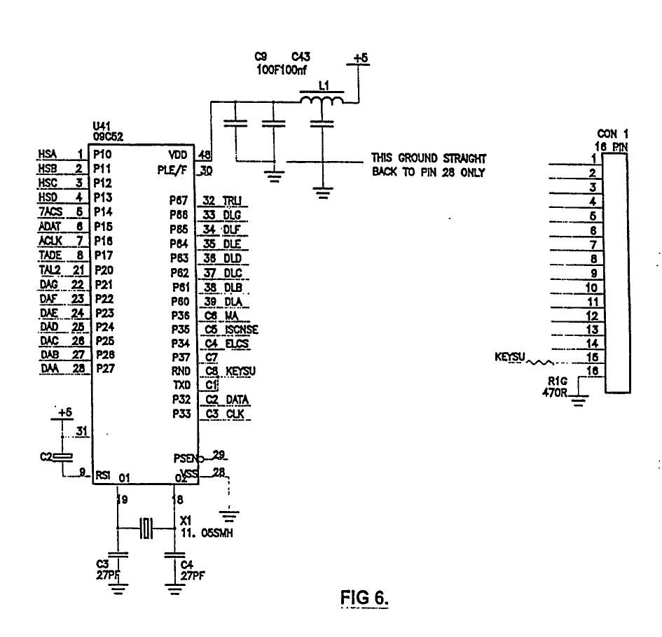

With respect to FIG. 5 of the drawings the present invention enables the environment to be subdivided into a plurality of heat zones A. The subdivisions may be on a tiered basis as illustrated or in vertical and horizontal rows. Items to be heated B may be placed in each of the zones.

The surface temperatures within each zone can be carefully and accurately monitored and if necessary quickly restored when the internal environment is disturbed, for example when an apparatus door is opened in order to gain access to the interiors of the apparatus. Such accurate monitoring and temperature control could not be achieved with existing heating and warming equipment which generally have large airspaces and heating systems which tend to over-react or react slowly when an internal temperature fall is detected.

There are numerous ways in which the body 1 may be designed and numerous shapes and configurations are possible. The technique of providing heated open shelves that don't rely on heated air may be adopted to provide made to order apparatus.

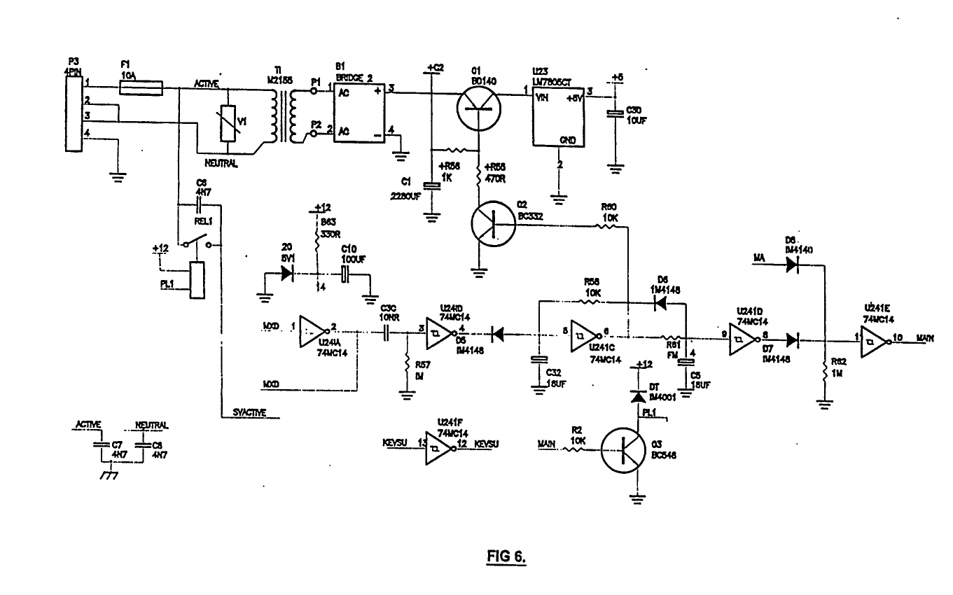

With respect to FIGS. 6 to 8 of the drawings, mains supply alternating current enters the controller via P3 and is protected from short circuit by the action of the Circuit Breaker CB1. Relay REL1 switches the mains supply to the heater element output stages under the control of the microcomputer U41 and its associated software.

Step down transformer T1 reduces the mains voltage to 9V AC as appropriate for the solid state electronics employed in the controller. Rectifier bridge B1 and capacitor C1 convert the 9V output from T1 to approximately 12V DC.

Transistors Q1, Q2, Q3 and integrated circuit U24 form a “software protection” scheme commonly known as a “watchdog”. This circuit switches the 12V DC available to the voltage regulator integrated circuit U23 off and on and prevents the main relay REL1 from being turned on via Q3 unless the microcomputer regularly toggles the MXD signal line shown entering pin 1 of U24. The purpose of this circuit is to reset the microcomputer in the event the software is not running correctly and preventing the mains alternating current being applied to the heating elements as a safety precaution.

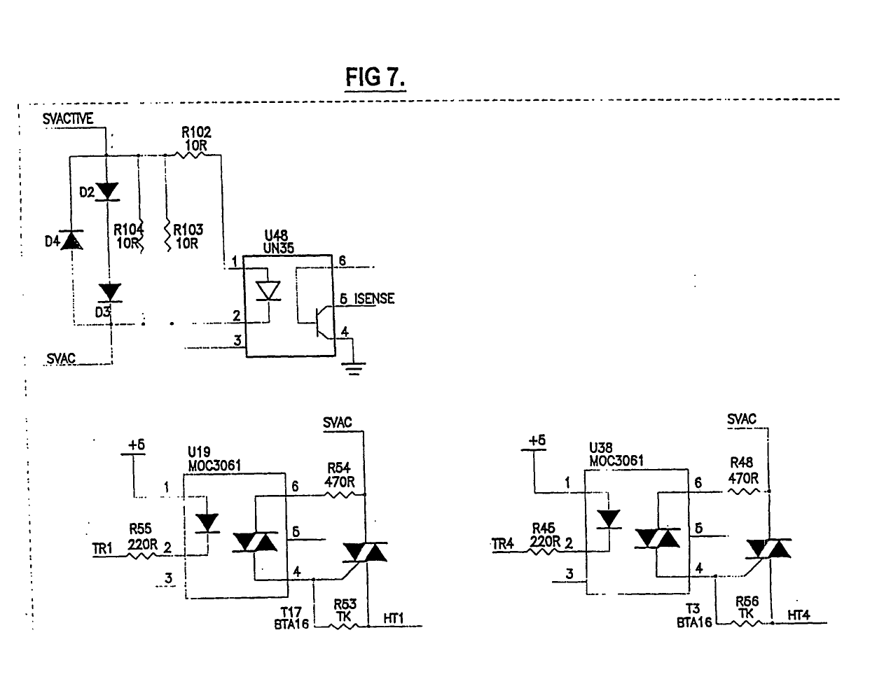

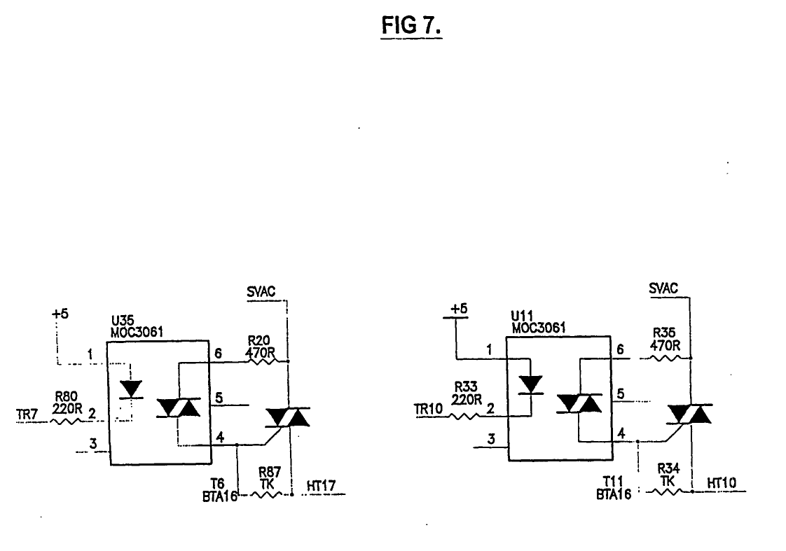

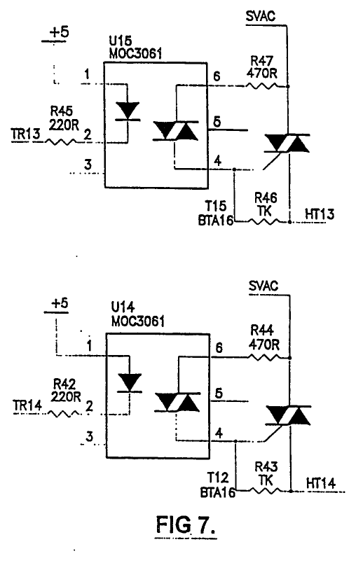

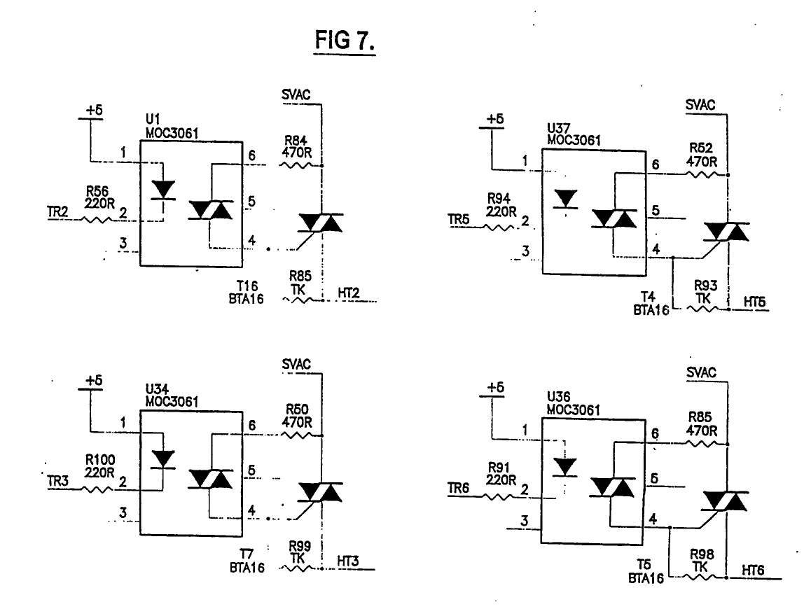

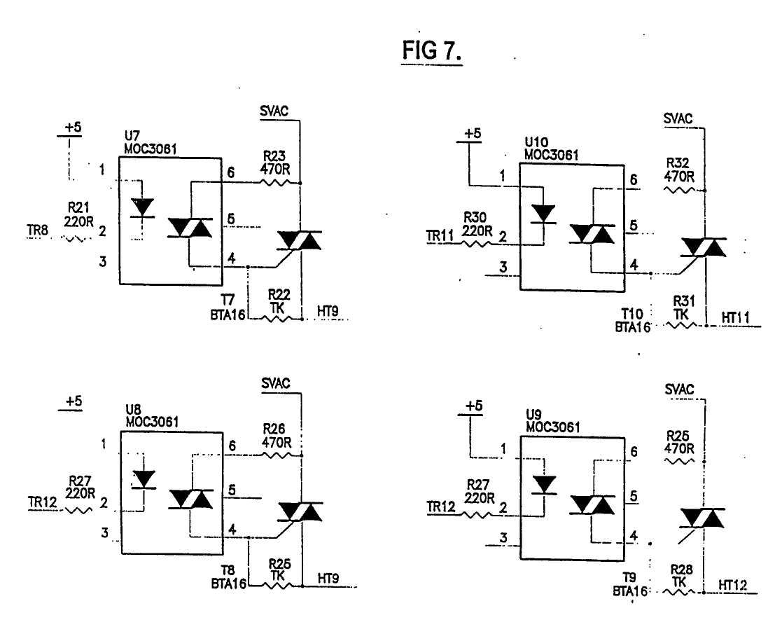

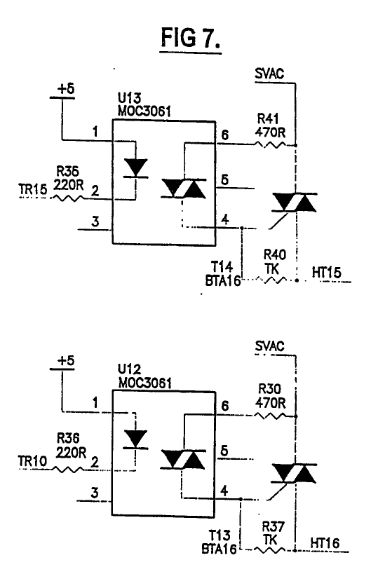

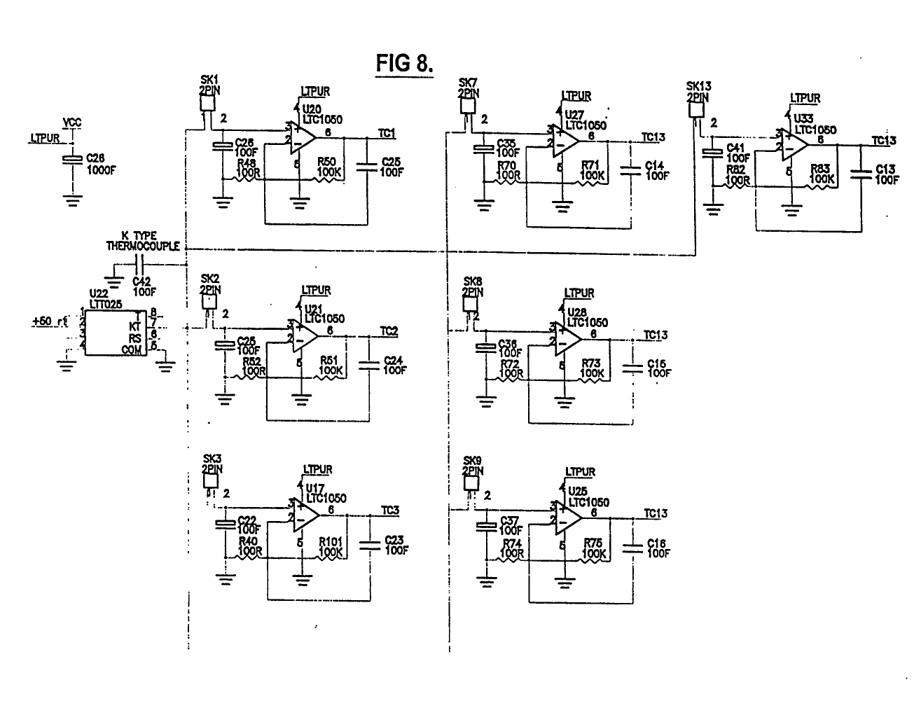

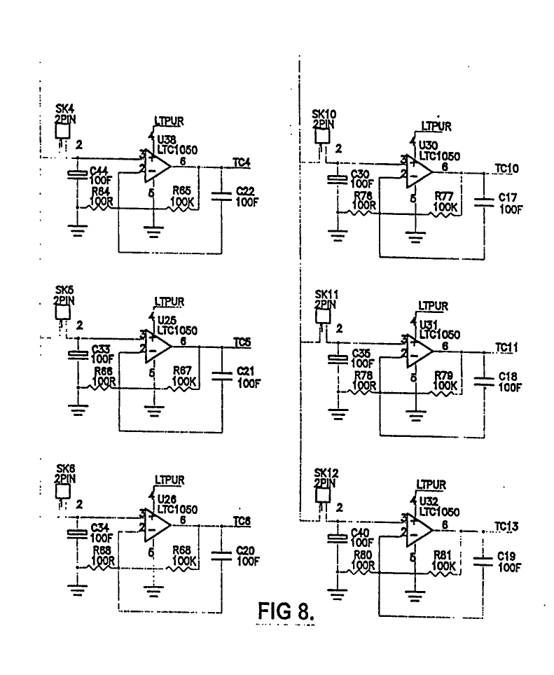

With respect to FIG. 7 mains alternating voltage switched by the relay REL1 (FIG. 6) as described above passes through the current sensing circuit of FIG. 8 comprising D2, D3, D4, resistors R102, R103, R104 and opto-coupler integrated circuit U40. The voltage drop produced by current flow through resistors R103 and R104 activates the LED section of the opto-coupler U40 which causes the output transistor within the device to conduct and pull the output line labelled ISENSE to a low logic level. By this action the microcomputer detects the presence or absence of current flow in the heater elements. This information is used by the software to detect failed components in the heater controlling circuitry or broken film and glass heated surfaces. The software removes the dangerous voltages from the heater elements if a fault is detected in these areas to prevent accidental injury to persons using the equipment.

One of a plurality of identical heater element control outputs is illustrated by FIG. 7. The construction and operation of each of the outputs is identical. Resistors R45, R46, R47, integrated circuit opto-coupler U15 and triac T15 form one of the heater control outputs and can be seen in the top right of FIG. 7.

When the control line from the microcomputer and its associated circuitry shown in FIG. 1 pulls the signal line marked TR13 low, current flows through R45 and lights the LED section of the opto-coupler integrated circuit U15. This causes the sensing section of U15 to conduct at the next zero crossing point of the mains alternating voltage and switch on triac T15. The opto-coupler employed performs the switch action at the zero crossing point so as to minimize the switching noise that is produced when the heater elements are switched on and off.

Each heater element is turned on or off by the microcomputer and its software as required to increase or decrease the temperature of that element respectively. The temperature of the elements is determined by temperature sensing devices processed by the temperature measurement circuits illustrated by FIG. 8.

K-type thermocouple temperature sensors are used to measure the temperature of the controller heating surfaces of the cabinet and the air within the cabinet. Integrated circuit U22 compensates for the cold junction of the thermocouple sensor formed where the thermocouple wiring connects to the printed circuit board housing the controller electronics.

On the ten (10) identical temperature measurement inputs is described in detail. The construction and operation of each of the inputs is identical. Resistors R82, R83, capacitors C13, C41 and integrated circuit operational amplifier U33 form on the temperature measurement circuits and can be seen in the top right of FIG. 8.

Integrated circuit operational amplifier U33 and resistors R82 and R83 form a precision amplifier with a gain of approximately one thousand (1000) times. It is essential that the operational amplifier employed has an offset voltage drift of less than forty micro-volt (40μV) over the operating temperature and life of the apparatus so that the temperature measurement error is kept below one degree Celsius (1° C.).

Capacitors C13 and C41 offer a high rejection at the frequency of the mains alternating voltage operating the electronics and heater elements of the apparatus. This filtering is essential to prevent the high level of noise coupled into the heater elements (which are in close proximity to the heater elements) from effecting the temperature measurement.

The amplified signal from the thermocouple, labelled as signal TC13, is connection to analogs to digital converter integrated circuit U18 shown in FIG. 6 where is converted into a digital representation of temperature for use by the microcomputer and software.

An example of the temperature profile which is achievable using the method according to the present invention is illustrated in FIG. 12.

The method for maintaining a preset relative humidity in a temperature maintained environment, the method comprising the steps of

monitoring the relative humidity in the environment,

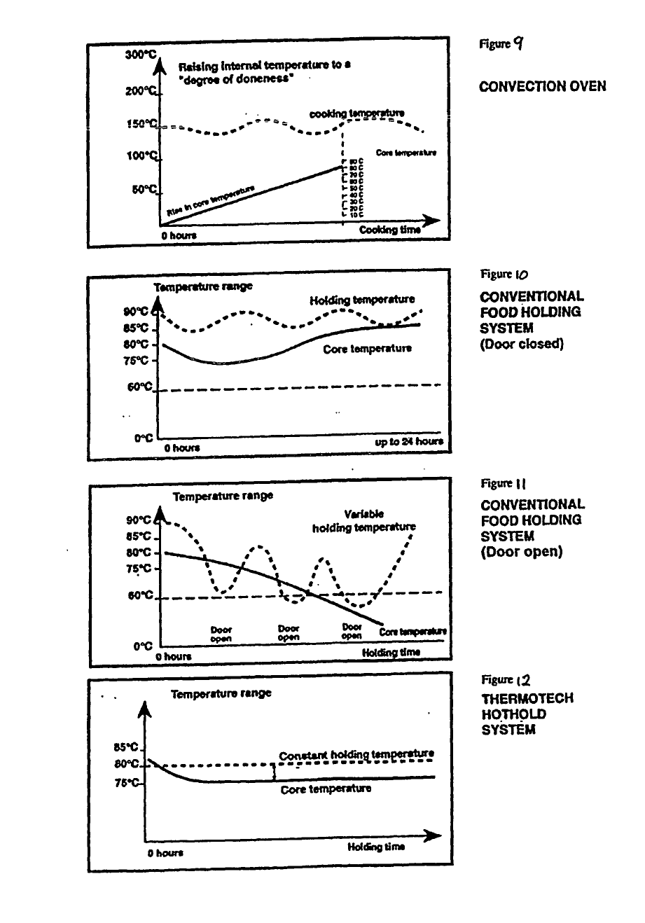

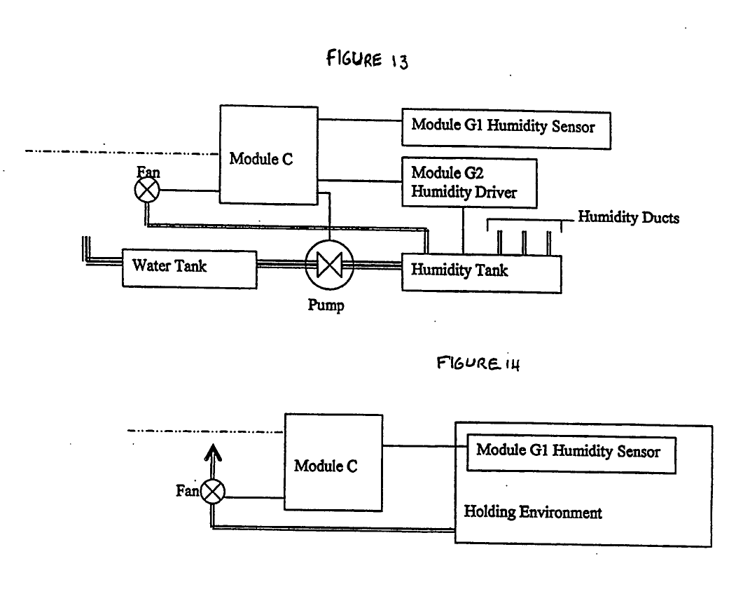

controlling the relative humidity in the environment by utilizing a humidifier if the relative humidity is too low and extracting excess humidity if the relative humidity is too high may be implemented using a system as illustrated in FIGS. 13 and 14.

The monitoring of the relative humidity levels in the environment will be performed using a humidity sensor. The moisture sensor is linked to a microprocessor or controller (Module C). The preset relative humidity desired in the environment is preset according to the type of food which is to be held in the environment. Typically, the controller may control the relative humidity in the environment such that the relative humidity is restricted to with ±5% of the preset value.

The humidifier will generally be an ultrasonic humidifier. An ultrasonic humidifier converts electrical energy into mechanical vibrations to generate an aerosol, thereby producing a very fine mist consisting of minute aerosol particles. The humidifier is associated with a water tank. Fans are provided to move the humidity into the environment.

The excess humidity may suitably be extracted from the environment using vents. The vents are associated with fans to assist in the extraction.

It will be appreciated that the apparatus and methodology described can be adapted for use in experimental and laboratory work, for maintaining a heating environment for medical or other purposes.

In the present specification and claims, the word “comprising” and its derivatives including “comprises” and “comprise” include each of the stated integers but does not exclude the inclusion of one or more further integers.

Reference throughout this specification to “one embodiment” or “an embodiment” means that a particular feature, structure, or characteristic described in connection with the embodiment is included in at least one embodiment of the present invention. Thus, the appearance of the phrases “in one embodiment” or “in an embodiment” in various places throughout this specification are not necessarily all referring to the same embodiment. Furthermore, the particular features, structures, or characteristics may be combined in any suitable manner in one or more combinations.

1. An improved food handling method for maintaining a hot food item at a desired temperature, the method comprising the steps of monitoring the heat load applied to at least a portion of a food support surface using at least one temperature sensor associated with the food support surface and a controller, and upon application of a heat load to the food support surface, the controller identifies a deviation from a zero heat load and applies power to at least one heating means associated with the food support surface based on the deviation.

2. An improved food handling method according to claim 1 wherein the controller applies the power to the at least one heating means relative to the deviation in heat load of at least a portion of the food support surface from a zero heat load.

3. An improved food handling method according to claim 2 wherein the controller interrogates the surface temperature of at least a portion of each food support surface, compares it to the preset temperature for that surface and utilizes the difference in the temperatures to calculate a heat load.

4. An improved food handling method according to claim 1 to provide the ability to raise or lower the core temperature of the food items without inducing “cook on” or beginning the cooking process in the food again.

5. An improved food handling method according to claim 1 used in an apparatus comprising a body, means of access to the interiors of the body and at least one internal shelf which is a laminate or sandwich of two metal panels and having an interposed electrically conductive serpentine coil adapted for connection to a power source.

6. An improved food handling method for heating cold food to a preset temperature and then maintaining the food item at a desired temperature, the method comprising the steps of
a. monitoring the heat load applied to at least a portion of a food support surface using at least one temperature sensor associated with the food support surface and a controller,
b. controlling the operation of at least one heating means in a first, heating condition in which upon application of a heat load to the food support surface, the controller identifies the heat load and applies power to the at least one heating means to increase the temperature of the food support surface to achieve a zero heat load as quickly as possible and a second, holding condition activated upon reaching the zero heat load, wherein the controller identifies any deviation from the zero heat load and applies power to the heating means based on the deviation.

7. An improved food handling method according to claim 6 wherein in the first, heating condition, the controller functions to calculate the differential of the at least a portion of a food support surface and adjusts the level of current fed to the at least one heating means associated with the food support surface to compensate for negative heat loads and raise temperatures of the food item to predetermined levels from 80 to 300° C. for heating chilled food for predetermined time periods in order to raise the internal temperatures from below a low-range foodsafe maximum temperature to above a high-range food safe minimum temperature in a minimum time period inhibit bacterial growth whilst not exceeding the amount of power available.

8. An improved food handling method according to claim 6 wherein in the second, holding condition, the controller functions to adjust the level of current fed to the at least one heating means associated with the at least a portion of a food support surface to compensate for negative heat loads and maintain predetermined temperatures in heated food above the minimum foodsafe temperature for hot food to inhibit bacterial growth in or on the food items, and below a cooking temperature of the food item or items whilst not exceeding the amount of power available.

9. An improved food handling method according to claim 6 used in a heating apparatus comprising a body, means of access to the interiors of the body and at least one internal shelf which is a laminate or sandwich of two metal panels and having an interposed electrically conductive serpentine coil adapted for connection to a power source.

10. An improved food handling method according to claim 1 further including s step for maintaining a preset relative humidity in a temperature maintained environment, the method including the steps of
a. monitoring the relative humidity in the environment,
b. controlling the relative humidity in the environment by utilizing a humidifier if the relative humidity is too low and extracting excess humidity if the relative humidity is too high.
